(19) United States
(12) Patent Application Publication
(10) Pub. No.: US 2023/0285969 A1
(43) Pub. Date: Sep. 14, 2023

(54) MICROFLUIDIC CHAMBER, MICROFLUIDIC DEVICE CONTAINING A WATER PURIFICATION SYSTEM, AND A WATER PURIFICATION METHOD

(71) Applicant: City University of Hong Kong, Kowloon (HK)

(72) Inventors: Bee Luan Khoo, Kowloon (HK); Chun Kwan Chen, New Territories (HK)

(21) Appl. No.: 17/691,498

(22) Filed: Mar. 10, 2022

(51) Int. Cl. B01L 3/00

(52) U.S. Cl. CPC B01L 3/502761; B01L 3/502753; B01L 2300/087; B01L 2300/088; C02F 1/00

(57) ABSTRACT

Microfluidic device for isolating a microparticle from a heterogeneous sample includes a first microfluidic chamber containing a first chamber inlet; a plurality of first chamber outlets in fluid connection with the first chamber inlet; and a loop. The microfluidic device further contains a second microfluidic chamber containing a second chamber inlet and a plurality of second chamber outlets in fluid connection with the second chamber inlet. The second microfluidic chamber contains a loop. In some embodiments, the first and second microfluidic chambers include from about 1 loop to about 50 loops; or from about 2 loops to about 25 loops; or from about 5 loops to about 15 loops. A first chamber outlet or a plurality of first chamber outlets is in fluid connection with the second chamber inlet. A method for removing a microparticle from a heterogeneous sample, and a water purification system and method use the microfluidic device.

### FIELD OF THE INVENTION

The present invention relates to the separation of micro particles, especially plastic microparticles, from a media, and specifically to the separation of microparticles from a media such as a liquid media.

### BACKGROUND

The use of plastic products has become an indispensable part of our lives and particles of various compositions are a commonplace nuisance. Microparticles (MP) is broadly defined as a particle, such as a cell, a biological particle, or a synthetic plastic, smaller than 5 mm, with various sizes, shapes, and compositions. MPs smaller than 500 µm and 25 µm can be further classified as small MP (sMP) and very small MP (vsMP), respectively. It is known that MPs are highly heterogeneous, which complicates the reliability of most size-based sorting techniques. Although pure plastics are usually non-toxic, harmful additives may be added/present during manufacturing and they may absorb toxic substances under polluted conditions.

The pollution of seawater by MPs, and especially plastic MPs, is a situation that impacts ecological and food safety issues globally. For example, plastic MPs containing harmful substances ingested by marine organisms will be transferred to the food web and influence food safety. See “Microplastic Pollution in Deep-Sea Sediments from the Great Australian Bight”, Barrett, et al., Frontiers in Marine Science, vo. 7, article 576170, DOI: 10.3389/fmars.2020576170, published 5 October, 2020. Due to the improper disposal of plastic MPs and the limitations of waste treatment, MPs are often found in natural environments such as soil, river, seawater, and freshwater systems leading to ecological risks. These environmental MPs could be ingested by organisms and transferred to the food web, posing a threat to food safety.

Apart from the food web, MPs have been found in commercially PET bottled water, which is also raises safety concerns. Although the amount of MPs in bottled water is usually present at a low level, especially for sMPs and vsMPs, humans may also consume MP through disposable plastic food and beverage containers widely used in the food industry. Especially during the COVID-19 pandemic and other situations which increase the demand for food and consumable delivery services. Studies have shown that MPs and sMPs can be leached from plastic containers through thermal or mechanical stress, but the long-term impact on humans is still not fully understood. For example, recent studies have proved that vsMPs are potentially more harmful to organisms because they have a high affinity for toxic substances and because vsMP can translocate into tissues and penetrate the blood-brain barrier, leading to irreversible brain damage and behavioral disorders.

Conventional procedures used to extract MP include density separation and pore-based filtration. For samples with high impurity content (i.e., non-plastics such as sediment), the saturated solution is carried out to remove impurities. Then the supernatant is filtered using a membrane with well-defined pores. Only the filtration step is required for samples with low impurity content (such as drinking water).

Although filtration and density separation are the most widely used methods (84%) to separate MP from seawater and sediments, the separation efficiency is still limited due to the heterogeneity of MP properties. For example, although membranes with microscopic pores are applied to filter vsMPs, smaller pores can lead to low throughput and clogging. Using saturated NaCl for density separation is cost-effective, but it is not suitable for higher-density MP. It has been proposed to use denser solvents such as ZnCl₂ and NaI to solve this problem, but they are either harmful or expensive. In addition, due to the long settling time, density separation is usually time-consuming and usually requires multiple extractions. Although some other methods, such as electrostatic-based, acoustic-based, or magnetic-based extractions, have been applied for MP recovery, their widespread utility remains limited due to the need for complex operations and their associated high costs. Furthermore, the existing MP separation methods, such as density separation and filtration, are limited by low efficiency and may be easy to clog during use.

Overall, according to literature references, current techniques have limitations that affect their sorting efficiency - see Table 1, below.

TABLE 1

| | | | |
|---|---|---|---|
| Technique | Principle | Advantages | Limitations |
| Sieving | Using sieve with specific mesh size where MPs larger than the mesh size | • Easy-to-use • Suitable for large volume of sample | • Used for larger MPs (e.g., > 300 µm) |
| | can be retained | • On-site extraction | • Effective for dried sample • Open system (contamination risk) |
| Filtration | Using membrane with well-defined pores where MPs larger than the pores can be retained | • Easy-to-use • Minimal equipment required • On-site extraction | • Low throughput for smaller MPs • Subject to clogging • Open system |
| Density separation (common solvents such as NaCl, ZnCl, NaI or SPT) | Applying higher density solvent to make lower density MPs buoyant in the mixture | • Low cost (NaCl) • Effective for the removal of high-density impurities (e.g., sand) | • Not applicable to higher density MPs (NaCl) • Time-consuming (settling time and multiple extractions) • Not applicable to < 1 µm MP (scaling law) • Harmful (ZnCl) or expensive (NaI and SPT) • Open system |
| Electrostatic extraction | Utilizing electrostatic field to separate nonconductive MPs from conductive impurities | • High recovery (100% for 63 -200 µm MPs) • Removal of > 98 % impurities | • High cost for the equipment • Extremely dried sample required • Time-consuming for sample pre-treatment |
| | | | • Open system |
| Acoustic extraction | Utilizing acoustic fields on the microfluidic channels to focus flowing MPs | • High recovery (> 95% for 15 -200 µm MPs) • Closed system (minimal contamination) | • Low flow rate (< 0.3 ml/min) • Low efficiency with rigid impurities • Risk of fragmentation |
| Magnetic extraction | Applying hydrophobic iron nano-particles to bind MPs for subsequently magnetic recovery | • High recovery (92% for 10 - 20 µm MPs) • Closed system | • Risk of fragmentation • Expensive for nano-particles • Sensitive to impurities (non-specific binding) • Time-consuming for sample pre-treatment |

As such, most techniques are incapable of on-site MP extraction, resulting in additional labor costs required to transfer samples to the laboratory and increased the risk of contamination.

In the last decade, inertial microfluidics using spiral channels for size-based separation has gained significant research interest because of its high throughput, simple structure, and excellent focused outcomes. Inertial focusing in a curvilinear channel is contributed by the balance of inertial life force (F_{L}) and Dean drag force (F_{D}). The F_{L} is the balance of the shear-gradient and wall-induced forces to make particles migrate across the streamlines to a specific position. At the same time, particles flowing in a curvilinear channel will also experience an F_{D}, which drags the particles moving alone with two circulating vortices (Dean vortices) across the width of channels due to a centrifugal pressure gradient in the radial direction. When particles migrate with the Dean vortices at the position of the inner channel, F_{L} and F_{D} are acting in opposite directions to make particles focused. Since F_{D} is highly size-dependent, only particles larger than a certain dimension (size threshold) will experience appreciable F_{L} to balance the F_{D}, resulting in a size-based particle separation.

Filtration is currently the most widely-used method (reported 84%) after density separation. However, most of these methods are usually time-consuming and ineffective with high-density MPs. For example, size-based filtration is mainly used for samples with a low impurity content as high levels of impurities tend to clog the filter. Furthermore, the smaller the filter aperture size, the lower the throughput, particularly when sorting smaller MPs. Other innovative methods are still limited by their inherent drawbacks and associated high costs. Furthermore, industrial-filtration equipment tends to be very large, permanently-installed, difficult to clean/replace, and difficult to maintain.

Once separated from a sample, MPs may be further analyzed by methods known in the art, such as optical identification with or without staining, Raman spectroscopy, O-PTIR spectroscopy, statistical analysis, etc.

A microfluidic device may contain a first microfluidic chamber and a plurality of chamber outlets and ten loops (see Chen, et al., “A portable purification system for the rapid removal of microplastics from environmental samples”, Chem. Eng. J 428, 132614, DOI: 10.1016/j.cej.2021.132614, published 24 Sept. 2021 by the inventors herein), however such a system does not successfully sort vsMPs, etc. from a homogenous sample.

Separation needs exist across different types of particles, such as cells and biological particles as well. Similarly, a microfluidic device may be used for testing biological samples (see Liao, et al., “Label-free biosensor of phagocytosis for diagnosing bacterial infections”, Biosensors and Biosciences 191, 113412, DOI: 10/1016/j.bios.2021.113412, published 11 Jun. 2021 by the inventors herein).

Accordingly there remains a need for effective devices and methods to remove small (< 500 µm Feret’s diameter) MPs in high impurity-content samples, and to effectively separate and distinguish MPs, sMPs, vsMPs, etc. from a homogenous sample. The need further exists for a rapid and inexpensive device and method possessing higher sorting efficiency and sorting of various sized MPs. Also, the need further exists for a portable MP, sMP, vsMP, etc. separation method. The need also exists fora closed MP, sMP, vsMP, etc. separation system to reduce labor costs for sample transfer and minimize contamination risk. In addition, there exists a need to separate other types of particles, such as, for example, cells, biological particles, etc. from bodily fluids.

### SUMMARY OF THE INVENTION

An embodiment of the present invention relates to a microfluidic device for isolating a microparticle from a heterogeneous sample including a first microfluidic chamber. The first microfluidic chamber contains a first chamber inlet and a plurality of first chamber outlets in fluid connection with the first chamber inlet. The first microfluidic chamber contains a loop; or from about 1 loop to about 50 loops; or from about 2 loops to about 25 loops; or from about 5 loops to about 15 loops. The microfluidic device further contains a second microfluidic chamber that contains a second chamber inlet and a plurality of second chamber outlets in fluid connection with the second chamber inlet. The second microfluidic chamber contains a loop; or from about 1 loop to about 50 loops; or from about 2 loops to about 25 loops; or from about 5 loops to about 15 loops. A first chamber outlet; or a plurality of first chamber outlets, is in fluid connection with the second chamber inlet.

An embodiment of the present invention relates to a method for removing a microparticle from a heterogeneous sample comprising the steps of injecting the heterogeneous sample into the first chamber inlet of the microfluidic device as described herein and collecting microparticle from the first chamber outlet.

An embodiment of the present invention relates to a water purification system including the microfluidic device herein.

An embodiment of the present invention relates to a method for purifying water including the method herein.

The present invention may possess one or more benefits such as high throughput, effective separation/isolation of microparticles, reduced contamination, portability, reduced size, high efficiency, energy-efficiency, and others.

### BRIEF DESCRIPTION OF THE DRAWINGS

FIG. 1 shows a top view, side view and a cut-away view of embodiment of the microfluidic chamber of the present invention;

FIG. 2 shows a schematic diagram of an embodiment of the sorting system of the present invention;

FIG. 3a shows a schematic diagram of the inertial life force and the Dean drag force on an MP;

FIG. 3b shows a schematic diagram of the inertial life force and Dean drag force acting on different-sized MPs;

FIG. 3c shows a schematic diagram of an embodiment of a large microfluidic chamber with a single inlet and five outlets;

FIG. 3d shows a photo of an embodiment of a large microfluidic chamber, with a 10 mm bar to show the size;

FIG. 3e shows a photo of an embodiment of an experimental setup comprising a syringe pump to control the sample flowrate within the microfluidic chamber;

FIG. 4 shows data of the highest partcicle recovery rates of 21 µm MPs at different selected flow rates (1.5 ml/min, 1.7 ml/min, 1.9 ml/min, and 2.1 ml/min);

FIG. 5a shows the particle recovery rates of 21 µm MPs;

FIG. 5b shows the particle recovery rates of 15 µm MPs;

FIG. 5c shows the particle recovery rates of 10 µm MPs;

FIG. 5d shows the particle recovery rates of 4.95 µm MPs;

FIG. 5e shows the particle recovery rates of 3 µm MPs;

FIG. 5f shows the particle recovery rates of 1 µm MPs;

FIG. 6a shows the representative image of irregular MPs;

FIG. 6b is a graph showing the iPSs′ corresponding aspect ratio (AR) distribution;

FIG. 6c is a graph showing the iPSs′ circularity;

FIG. 6d is a graph showing the iPSs′ diameter in µm;

FIG. 7a shows the PRR distribution of 27-50 µm iPS MPs;

FIG. 7b shows the PRR distribution of 25 ± 2 µm iPS MPs;

FIG. 7c shows the PRR distribution of 21 ± 2 µm of iPS MPs;

FIG. 7d shows the PRR distribution of 27-50 µm irregular polyamide (iPA) MPs;

FIG. 7e shows the PRR distribution of 25 ± 2 µm iPA MPs;

FIG. 7f shows the PRR distribution of 21 ± 2 µm of iPA MPs;

FIG. 7g shows the PRR distribution of 27-50 µm irregular polyethylene terephthalate (iPET) MPs;

FIG. 7h shows the PRR distribution of 25 + 2 µm iPET MPs;

FIG. 7i shows the PRR distribution of 21 ± 2 µm of iPET MPs;

FIG. 8a, shows the PRR distribution of iPS MPs 12-19 µm in diameter;

FIG. 8b shows the PRR distribution of iPS MPs 10 ± 2 µm in diameter;

FIG. 8c shows the PRR distribution of iPS MPs < 8 µm in diameter;

FIG. 8d shows the PRR distribution of iPA MPs 12-19 µm in diameter;

FIG. 8e shows the PRR distribution of iPA MPs 10 ± 2 µm in diameter;

FIG. 8f s shows the PRR distribution of iPA MPs < 8 µm in diameter;

FIG. 8g shows the PRR distribution of iPET MPs 12-19 µm in diameter;

FIG. 8h shows the PRR distribution of iPET MPs 10 ± 2 µm in diameter;

FIG. 8i shows the PRR distribution of iPET MPs < 8 µm diameter;

FIG. 9 shows a PRR graph of iPS, iPA and iPET MPs 19-50 µm in diameter according to two groups of outlets in a system similar to that of FIGS. 3c and 3e.

FIG. 10a shows schematic workflow diagram of an embodiment of a spiked seawater preparation, separation and analysis using a microfluidic chamber;

FIG. 10b shows ≥ 19 µm MP PRRs spiked into the seawater of FIG. 10a, when tested by the invention similar to that seen in FIGS. 3c and 3e;

FIG. 10c shows < 19 µm MP PRRs spiked into the seawater of FIG. 10a, when tested by the invention similar to that seen in FIGS. 3c and 3e;

FIG. 11a shows a representative Raman spectra graph and photo of iPS MPs recovered from Outlet Group 2;

FIG. 11b shows a representative Raman spectra graph and photo of iPA MPs recovered from Outlet Group 2;

FIG. 11c shows a representative Raman spectra graph and photo of iPET MPs recovered from Outlet Group 2;

FIG. 11d shows a representative background spectrum, which was the result of averaging five spectra taken without MP;

FIG. 12a shows a schematic diagram of an embodiment of the present invention integrating a feedback loop allowing simultaneous MP sample concentration and water purification;

FIG. 12b shows a photo of the embodiment of FIG. 12a;

FIG. 12c shows a Raman spectrum of isolated PET MPs and the reference spectrum;

FIG. 13a shows an embodiment of a schematic workflow diagram of a MP sorting protocol analysis from deep-sea sediment using the microfluidic chamber;

FIG. 13b shows the count of all recovered MPs (15-215 µm) at Outlets 1, 2, 3 and Outlets 4, 5 respectively;

FIG. 13c shows the representative fluorescence images of the recovered Nile red-stained MPs (red);

FIG. 14a shows the representative spectra of a PS MP that recovered from deep-sea sediment;

FIG. 14b shows the representative spectra of a polyethylene (PE) MP that recovered from deep-sea sediment;

FIG. 15a shows the PRR of ≥ 19 µm MPs collected from polypropylene (PP) food containers;

FIG. 15b shows the PRR of < 19 µm MPs collected from polypropylene (PP) food containers;

FIG. 15c shows a representative optical microscopy image of the particles from a PP container;

FIG. 15d shows a representative Raman spectrum of the enriched MPs (pink) and a PP reference spectrum;

FIG. 16a shows a schematic diagram of an embodiment of a large microfluidic chamber;

FIG. 16b shows a schematic diagram of an embodiment of an intermediate microfluidic chamber;

FIG. 16c shows a schematic diagram of an embodiment of a small microfluidic chamber; and

FIG. 17 shows a schematic diagram of an embodiment of a sorting system with multiple microfluidic chambers connected in series.

The figures herein are for illustrative purposes only and are not necessarily drawn to scale.

### DESCRIPTION OF THE PREFERRED EMBODIMENTS

Unless otherwise specifically provided, all tests herein are conducted at standard conditions which include a room and testing temperature of 25° C., sea level (1 atm.) pressure, pH 7. Whenever possible, glass equipment is used, and all procedures are carried out within a fume cabinet or biological safety cabinet to avoid airborne contamination. Unless otherwise stated, all measurements are made in metric units. Furthermore, all percentages, ratios, etc. herein are by weight, unless specifically indicated otherwise. It is understood that unless otherwise specifically noted, the materials compounds, chemicals, etc. described herein are typically commodity items and/or industry-standard items available from a variety of suppliers worldwide.

As used herein the term “microparticle” (MP) indicates a particle, such as a plastic MP, having its largest Feret’s Diameter of less than about 5 mm. Plastic MPs may be, for example, originally-produced at this size, an agglomeration of multiple pieces, broken off from or otherwise originating from larger pieces of plastic, etc.

As used herein the term “small microparticle” (sMP) indicates a particle, such as a plastic sMP, having its largest Feret’s Diameter between about 500 µm and about 25 µm and may be, for example, originally-produced at this size, an agglomeration of multiple pieces, broken off from or otherwise originating from larger pieces of plastic, etc.

As used herein the term “very small microparticle” (vsMP) means a particle, such as a plastic vsMP, having its largest Feret’s Diameter of less than about 25 µm and may be, for example, originally-produced at this size, an agglomeration of multiple pieces, broken off from or otherwise originating from larger pieces of plastic, etc.

The particles in the MPs herein may be selected from the group of a plastic particle, a sand particle, a biological particle, a sediment particle, a stone particle, and a combination thereof; or an organic particle, a cell, a protein, and a combination thereof. the plastic may be selected from the group of polystyrene, polyethylene, polyamide, polyester, polyacetate, and a combination thereof; or polyethylene terephthalate, polystyrene, polyamide, polyester, and a combination thereof.

An embodiment of the present invention includes a microfluidic device for isolating a microparticle from a heterogeneous sample including a first microfluidic chamber. The first microfluidic chamber contains a first chamber inlet and a plurality of first chamber outlets in fluid connection with the first chamber inlet. The first microfluidic chamber contains a loop; or from about 1 loop to about 50 loops; or from about 2 loops to about 25 loops; or from about 5 loops to about 15 loops.

The microfluidic device further contains a second microfluidic chamber that contains a second chamber inlet and a plurality of second chamber outlets in fluid connection with the second chamber inlet. The second microfluidic chamber contains a loop; or from about 1 loop to about 50 loops; or from about 2 loops to about 25 loops; or from about 5 loops to about 15 loops. A first chamber outlet; or a plurality of first chamber outlets, is in fluid connection with the second chamber inlet.

In an embodiment of the microfluidic device herein the first microfluidic chamber is larger; or at least 50% larger; or from about 50% to about 1000% larger; or from about 100% to about 500% larger than the second microfluidic chamber in at least one dimension.

Without intending to be limited by theory, it is believed that the present invention provides an inertial-based microfluidic separation device, technique, and system useful for MP detection, separation, isolation, etc. as well as the converse which is purification of the MPs and/or the sample media. Without intending to be limited by theory, it is believed that by serially-connecting a first microfluidic chamber with second microfluidic chamber as described herein, high throughput rates of up to about 8.5 ml/min can be achieved which is faster than most other existing techniques. In addition, it is believed that the present invention avoids the MP fragmentation often caused by acoustic and magnetic extraction techniques. It is also believed that the present microfluidic chambers may be able to isolate/separate larger MPs than many of the reported literature.

Furthermore, the present invention may be operated in a closed system so as to avoid both internal and external contamination. The current invention further avoids the need for expensive instruments, expensive and/or dangerous solvents, and requires minimal laboratory equipment. The present invention is easily operated with minimal training, and equipment, and is easily calibrated and modified. Furthermore, the concentrating effect of the present microfluidic chamber may allow more sensitive detection of MPs and/or the isolation of MPs from very low concentrations. As such, the present invention is also quite portable and may be used on-site where contamination occurs, as a rapid, simple, low-cost, and portable MP removal and/or detection method with minimal setup and calibration. Such a device and method are especially useful in locations with minimal resources, power, etc. as well as being suited for the laboratory. It is also possible to employ the microfluidic chambers herein to concentrate MPs from large volumes, for example, sear water samples, from low MP concentrations to high MP concentrations and the converse - to remove MPs so as to purify water. The samples can be an environmental sample, a bodily fluid sample, an experimental sample, and a combination thereof; or a river sample, a marine sample, a sediment sample, a wastewater sample, a freshwater sample, and a combination thereof; or a blood sample, a bile sample, a stomach acid sample; a plasma sample, and a combination thereof.

Without intending to be limited by theory, it is believed that the presence of loops in the microfluidic chamber(s) allows the use of inertial focusing-based microfluidics which helps to concentrate particles of specific sizes by balancing the inertial lift force (F_{L}) and the Dean drag force (F_{D}) in a fully-enclosed system.

To obtain a balance between the inertial and viscous effects experienced within the microfluidic system, the ratio of the inertial force to the viscous force, termed as Reynolds number (Re), should be between 1 to 100 (~1< Re <~100). Re is given by:

$$R e = \frac{ρ U D}{μ} \qquad \text{(1)}$$

where ρ, U, µ and D represent the liquid density, flow velocity, viscosity, and hydraulic diameter, respectively.

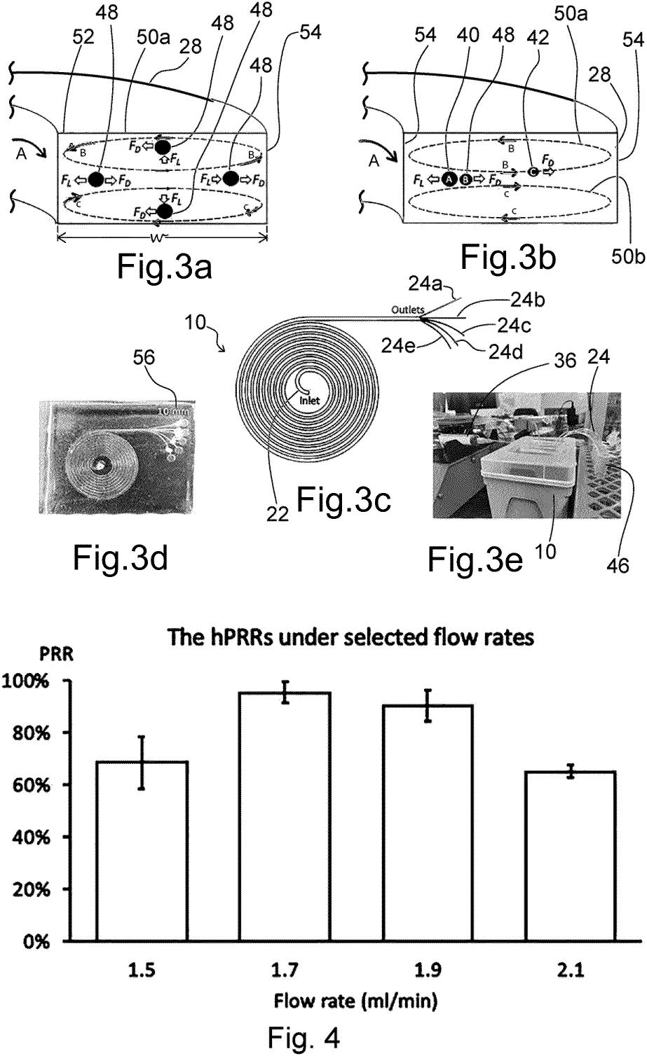

For a channel with a rectangular cross-section, D = 2hw/(h+w) where h and w are the channel cross-section height and width. In inertial focusing-based microfluidics, shear-induced life force and wall-induced life force will make particles migrate across the streamlines. Inertial life force (F_{L}) acting on the particles is the resultant force of the shear-induced life force and wall-induced life force, which is given by:

$${F}_{L} = \frac{ρ {C}_{L} {U}^{2} {a}^{4}}{{D}^{2}} \qquad \text{(2)}$$

where C_{L} is lift co-efficient, and a is the particle diameter. When fluid flows in curvilinear channels, a centrifugal pressure gradient in the radial direction will drag the particles moving back and forth across the width of channels (see FIG. 3a). This drag force, defined as Dean drag force (F_{D}), can be calculated by:

$${F}_{D} = 3 π {U}_{D} a \qquad \text{(3)}$$

Where U_{D} is defined as Dean flow (vortices velocity), that can be estimated by:

$${U}_{D} = 1.8 \times {10}^{- 4} R e {\sqrt{\frac{D}{2 R}}}^{1.63} \qquad \text{(4)}$$

where R is the radius of channel curvature.

According to Equations (2) and (3), the F_{L} is more dependent on particle diameter than F_{D} (i.e., F_{L} ∝ a³ and F_{D} ∝ a). Therefore, only particles larger than specific diameters will experience appreciable F_{L}, which is sufficient to balance the F_{D} and facilitate focusing (see FIG. 3b). The threshold diameter for particles to be focused in the system is proportional to the channel dimensions [16, 26] and is estimated by:

$$\frac{a}{D} \geq 0.07 \qquad \text{(5)}$$

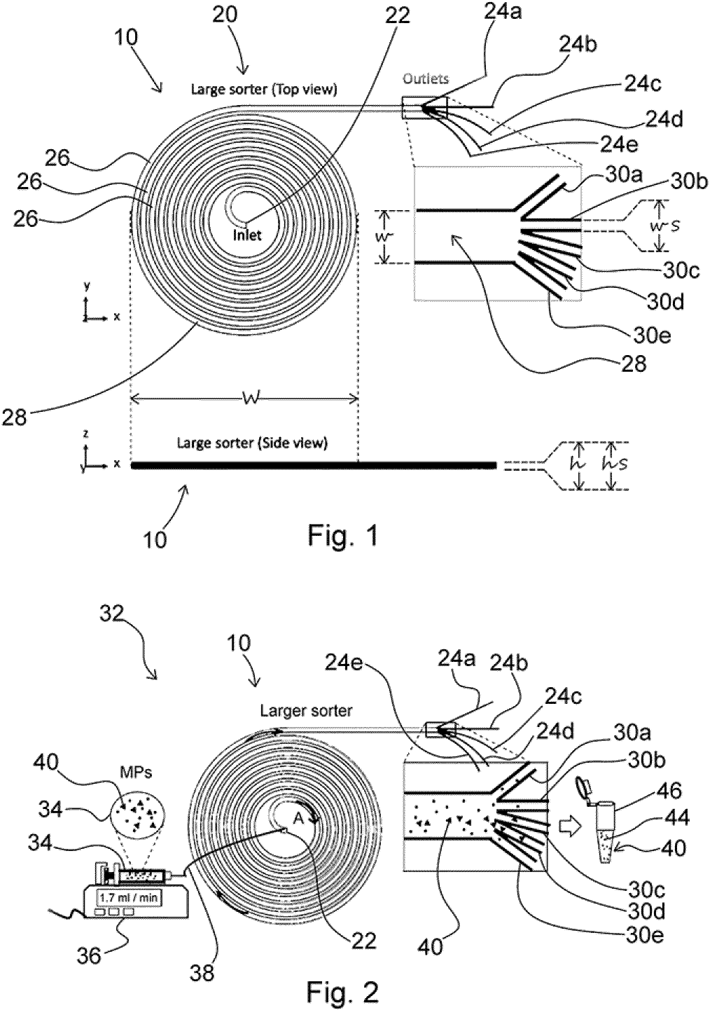

Based on Equations (1) to (5), we designed the microfluidic device (FIG. 1) to separate MPs with a size threshold of about 20 µm. We characterized the efficacy of the device using the particle recovery rate (PRR), which is commonly used to quantify the sorting efficiency in the field of microfluidics.

The PRR is given by:

$$\begin{matrix}\text{Particle recovery rate} \left(\text{PRR}\right) = \frac{\text{No} \text{.of particles at each Outlet}}{\text{No} \text{.of particles at all Outlets}} \times \\ 100 \% .\end{matrix}$$

Furthermore, it is believed that the combination of the size differential between the first microfluidic chamber and the second microfluidic chamber and the serial connecting of the first chamber outlet to the second chamber inlet allow the microfluidic chambers to sequentially filter smaller and smaller particles from the heterogeneous sample.

In an embodiment herein, the plurality of first chamber outlets, second chamber outlets, third chamber outlets, etc. is from about 2 outlets to about 20 outlets; or from about 2 outlets to about 15 outlets; or from about 3 outlets to about 10 outlets; or about 3 outlets; or about 5 outlets. Without intending to be limited by theory, it is believed that the greater number of outlets, the more tightly the output can be achieved for each particle size; however, it is recognized that a narrower channel will be more subject to clogging, especially when larger particles/impurities are usually involved in the sample with a high impurity content (e.g., deep-sea sediments). Hence, an embodiment herein is a 5-outlet microfluidic chamber. This is designed taking into consideration the smallest dimension of each outlet into account (e.g., the width of each outlet: 500 µm/5 = 100 µm). Without intending to be limited by theory, it is believed that the greater the number of outlets, the greater the internal resistance which in turn could reduce throughput. In contrast, where the outlets are smaller, it has been found that a smaller number of outlets is more useful because each individual outlet will be larger and therefore less subject to clogging and blockage. In an embodiment herein, the aforementioned problems may be alleviated by widening the main channel in-between the end of the spiral loops and before the outlets split off, so as to allow additional outlets, even for smaller main channel dimensions.

According to Equation (1), the flow rate ranges from 0.021 ml/min to about 2.1 ml/min, corresponding to the Reynolds number (Re) required by the microfluidic system (~1< Re <~100). To determine the flow rate needed for maximum separation efficiency (or PRR), we processed samples with 21 µm polystyrene (PS) microspheres within the microfluidic device under various flow rates (1.5-2.1 ml/min). 21 µm was the theoretical threshold estimated by Equation (5) derived by using PS microspheres [28]. Since samples processed at 1.7 ml/min achieved the maximum recovery rate (FIG. 4), subsequent runs were carried out under this flow rate.

In an embodiment herein, the predetermined-sized particles in the heterogeneous sample contain a plastic. The heterogeneous sample herein is a sample, typically taken from the environment, which contains plastic particles; or MPs, of various sizes. The heterogeneous sample may contain, for example, a plastic, sediment, silt, a live and/or deceased organism, etc. and mixtures thereof, especially if the heterogeneous sample is taken from, for example, a lake, a river, the ocean, etc. In an embodiment herein, the plastics contain an MP, a sMP, a vsMP, and a combination thereof. In an embodiment herein, the heterogeneous sample includes water; or water selected from the group of lake water, river water, seawater and a combination thereof; or seawater.

In an embodiment herein, the microfluidic device further contains a third microfluidic chamber containing a third chamber inlet and a plurality of third chamber outlets in fluid connection to the third chamber inlet. The third microfluidic chamber contains a loop; or from about 1 loop to about 50 loops; or from about 2 loops to about 25 loops; or from about 5 loops to about 15 loops. The second microfluidic chamber is larger; or at least 50% larger; or from about 50% to about 1000% larger; or from about 100% to about 500% larger than the third microfluidic chamber in at least one dimension. Also at least one of the plurality of second chamber outlets is in fluid connection with the third chamber inlet. In a further embodiment, the microfluidic device herein may contain any number of serially-connected additional microfluidic chambers.

Without intending to be limited by theory, it is believed that by serially-connecting a third microfluidic chamber to at least one of the second chamber outlets allows further particle recovery and/or purification of the heterogeneous sample.

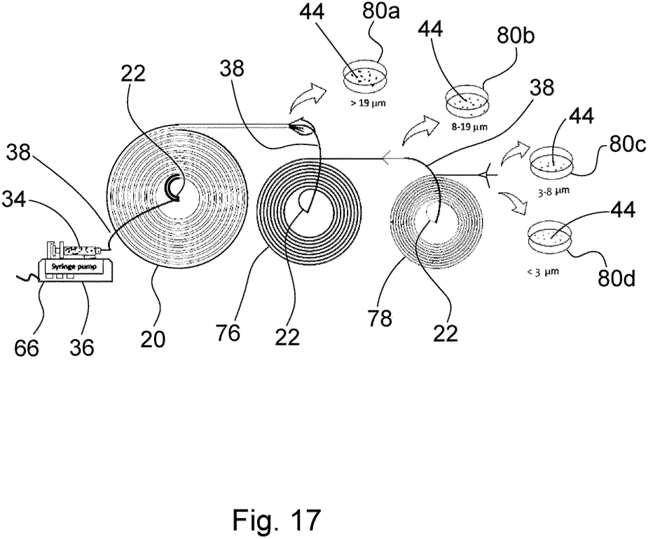

In an embodiment herein, multiple second microfluidic chambers are connected in serial to the first microfluidic chamber, but in parallel to other second microfluidic chambers (see FIG. 17).

In an embodiment herein, the microfluidic device may be calibrated and/or designed to handle particles of a predetermined size. Such predetermined-sized particles may be from about 5 mm to about 0.1 µm; or from about 1 mm to about 0.5 µm; or from about 500 µm to about 1 µm, as measured across the predetermined-sized particle’s largest Feret’s Diameter. If even larger particles are believed to be in the heterogeneous sample, then the microfluidic device may further contain, for example, a filter or other feature known in the art to remove the larger particles by, for example, filtering them out of the heterogeneous sample prior to injecting the heterogeneous sample to the first chamber inlet.

The microfluidic device herein may be formed by various methods and from various materials known in the art. For example, the various microfluidic chambers herein may be formed from plastic; or loops of plastic; or polydimethyl siloxane. Without intending to be limited by theory, it is believed that the typical microfluidic chamber material possesses one or more properties such as sufficient mechanical strength, optical transparency, non-toxic, and/or is inexpensive. In an embodiment herein, the main channel and/or the sub-channel(s) may be coated so as to increase the hydrophobicity or increase the hydrophilicity as desired. Without intending to be limited by theory, it is believed that a more hydrophilic surface can reduce adhesion of MPs, and especially plastic MPs, to the inner surface of the channels.

In an embodiment herein, at least a portion of the microfluidic device produced by a method comprising lithography, 3D printing, and a combination thereof.

In an embodiment herein, the microfluidic device herein is combined with other known particle isolation devices and techniques such as, filtration, density separation, Electrostatic extraction, Acoustic extraction, Magnetic extraction, and a combination thereof.

An embodiment of the present invention relates to a method for removing a microparticle from a heterogeneous sample comprising the steps of injecting the heterogeneous sample into the first chamber inlet of the microfluidic device as described herein and collecting microparticle from the first chamber outlet, the second chamber outlet and a combination thereof; or from the first chamber outlet, the second chamber outlet, the third chamber outlet and a combination thereof; or from additional outlets from additional added chambers as desired and according to the microfluidic device design.

In an embodiment herein, a water purification system may contain the microfluidic device herein and a method for purifying water may include the method described herein. The water purification system may, for example, contain the microfluidic device herein modified so as to continuously concentrate samples by incorporating one or more feedback loops. As such, an embodiment of the water purification system herein includes a feedback loop with the microfluidic device for the simultaneous concentration and purification of MPs from a heterogeneous sample, such a, for example, water; or water selected from the group consisting of lake water, river water, seawater and a combination thereof; or seawater; or bottled water, or PET bottled water.

Turning to the figures, FIG. 1 shows a top view, a side view, and a cut-away view of an embodiment of a microfluidic chamber, 10, of the present invention. The microfluidic chamber, 10, is a large microfluidic chamber, 20, with one inlet, 22, and five outlets, collectively, 24 and individually 24a, 24b, 24c, 24d, 24e. The large microfluidic chamber, 22, has ten spiral loops. 26. The main channel, 28, starting from inlet to all spiral loops has fixed rectangular cross-sectional width, w, of 500 µm and a cross-sectional height, h, of 220 µm. After the main channel, 28, equally splits into five sub-channels, collectively, 30 and individually 30a, 30b, 30c, 30d, 30e, as seen in the cut-away view shown in the inset, each sub-channel, 30, has a sub-channel width, ws, of 100 µm, which is one-fifth of the cross-sectional width, w, of the main channel, 28. Considering the geometry of the spiral loops, 26, the outermost outlet, 24, is considered to be outlet 24a and the outermost sub-channel, 30, is considered to be sub-channel 30a. Conversely, the innermost outlet, 24, is considered to be outlet 24e and the innermost sub-channel, 30, is considered to be sub-channel 30e. The middle outlet, 24, is outlet 24c, and the middle sub-channel, 30, is sub-channel 30c. Each sub-channel, 30, also has a sub-channel height, hs, of 220 µm which is the same as the cross-sectional height, h. It can be further seen that each sub-channel, 30, terminates in an outlet, 24, and that the splitting off location of the first sub-channel, 30a, from the main channel, 28, is very close to the splitting off of the last two sub-channels, 24d and 24e. The large microfluidic chamber has a microfluidic chamber width, W, of 2 cm.

FIG. 2 shows a schematic diagram of an embodiment of the sorting system, 32, of the present invention. A MP sample, 34, is located in a syringe pump, 36, which introduces the MP sample, 34, into the inlet, 22, of the microfluidic chamber, 10, via a tube, 38. to the inlet of the microfluidic chamber via syringe pump under optimal flow rate (1.7 ml/min). After passing through all ten spiral loops, 26, the larger MPs, 40, indicated with triangles, ▲, are focused into the center channel positions, 30c and 30d, and thus they can be concentrated into outlets 24c and 24d. In contrast, many of the smaller MPs, 42, indicated with dots, •, are concentrated into the outer channel positions, 30a, 30b, and 30e, which correspond to outlets 24a, 24b, and 24e. The sample, 44, collected in a collection container, 46, from outlets 24c and 24d, contain a high proportion of the larger MPs, 40, whereas the liquid from the outlets 24a, 24b, and 24e contain a larger proportion of smaller MPs, 42.

FIG. 3a shows a schematic diagram of the inertial life force, F_{L}, and the Dean drag force, F_{D}, on an MP, 48, in the curvilinear main channel, 28. The MP, 48, flowing in curvilinear main channel, 28, experiences the inertial life force, F_{D}, which drags the MP, 48, along with the Dean vortices, 50a and 50b, across the cross-sectional width, w, of the main channel, 28, and the cross-sectional height, h. The upper Dean vortex, 50a, rotates in the direction of arrow A, while the lower dean vortex, 50b, rotates in the direction of arrow B. The sample MPs, 48, and the sample, 44, are flowing in the curvilinear main channel, 28, in the direction of arrow C. At the inner channel edge, 52, the inertial life force, F_{L}, and Dean drag force, F_{D}, are in opposite directions to facilitate MP, 48, equilibration. At the outer channel edge, 54, the inertial life force, F_{L}, and Dean drag force, F_{D}, are in the same direction. In the upper middle of the main channel, 28, the inertial life force, F_{L}, pushes the MP, 48, up and the Dean drag force, F_{D}, pushes the MP, 48, towards the inner channel edge, 52. In the lower middle of the main channel, 28, the inertial life force, F_{L}, pushes the MP, 48, down and the Dean drag force, F_{D}, pushes the MP, 48, towards the inner channel edge, 52.

FIG. 3b shows a schematic diagram of the inertial life force, F_{L}, and the Dean drag force, F_{D}, acting on a larger MP, 40, a MP, 48, and a smaller MP, 42. As can be seen in FIG. 3b, the focusing position of a larger MP, 40, traveling in the direction of arrow C, is generally closer to the inner channel edge, 52, than a middle sized MP, 48. However, smaller MP, 42, does not experience appreciable inertial life force, F_{L}, and therefore tends to move further along with the Dean vortices, 50a and 50b, pushing the smaller MP, 42, towards the outer channel edge, 54.

FIG. 3c shows a schematic of a large microfluidic chamber, 10, with a single inlet, 22, and five outlets, 24a, 24b, 24c, 24d, 24e.

FIG. 3d shows a photo of an embodiment of a large microfluidic chamber, 10, with a 10 mm bar, 56, to show the size

FIG. 3e shows a photo of an embodiment of an experimental setup comprising a syringe pump, 36, to control the sample flow rate within the microfluidic chamber, 10. Also shows are a plurality of collection containers, 46, to collect the samples coming from the various outlets, 24.

FIG. 4 shows data of the highest particle recovery rates (hPRRs) of 21 µm MPs, in this case microspheres, at different selected flow rates (1.5 ml/min, 1.7 ml/min, 1.9 ml/min, and 2.1 ml/min). The data is shown as mean ± SD of three independent experiments.

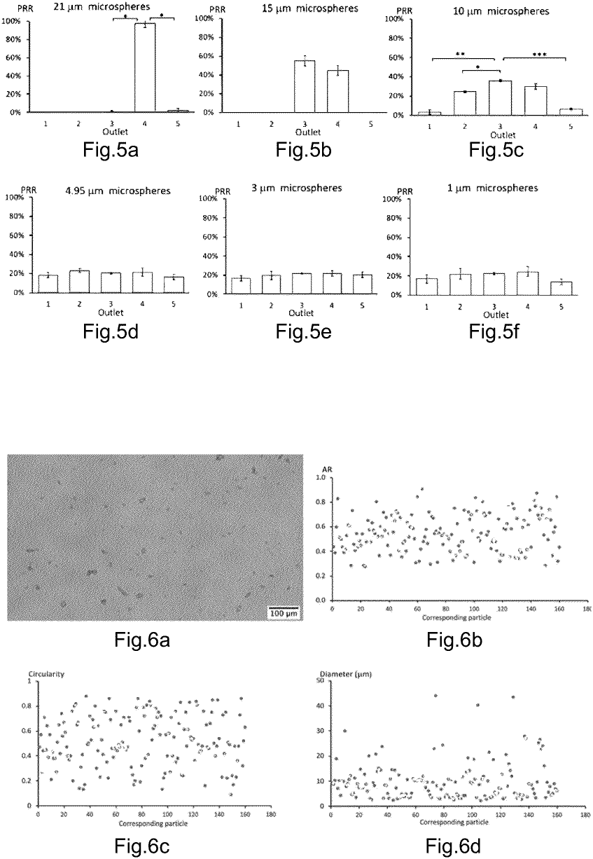

FIG. 5a shows the particle recovery rates (PRRs) of 21 µm (diameter) MPs with the highest recovery in outlet 4., FIG. 5b shows the PRRs of 15 µm MPs with the highest recovery in outlet 3, followed by outlet 4. FIG. 5c shows the PRRs of 10 µm MPs with the highest recovery in outlet 3, outlet 4, and then outlet 2. FIG. 5d shows the PRRs of 4.95 µm MPs with the recovery roughly equal in outlets 1-5. FIG. 5e shows the PRRs of 3 µm MPs with the recovery roughly equal in outlets 1-5. FIG. 5f shows the PRRs of 1 µm MPs with the recovery roughly equal in outlets 1-5. All MPs in FIGS. 5a-5F are polystyrene (PS) MPs, specifically microspheres, respectively, using a microfluidic chamber similar to that of FIG. 3c and FIG. 3e. Thus, in FIGS. 5a-5f, outlet 1 = outlet 24a, outlet 2 = outlet 24b, outlet 3 = outlet 24c, outlet 4 = outlet 24d, and outlet 5 = outlet 24e of FIG. 3c,. FIG. 5a shows that 21 µm microspheres were well focused in outlet 24d, and the threshold of the large microfluidic chamber is about 21 µm. It can also be seen in FIG. 5b that the 15 µm MPs were mostly concentrated in outlets 24c and 24d, while the concentration of the smaller MPs were less concentrated. The experiment excluded the use of > 21 µm PS MPs for threshold optimization because of the very high PRR (97.1%) achieved using 21 µm microspheres, and thus the more accurate threshold, if any, should be < 21 µm. Data shown is the mean ± SD of three independent experiments; *p < 0.01, **p < 0.001, ***p < 0.0001.

FIGS. 6a-6d show representative images of irregular MPs, in this case irregular polystyrene particles (iPSs). Specifically,FIG. 6a shows the representative images. FIG. 6b is a graph showing the iPSs′ corresponding aspect ratio (AR) distribution which is calculated as the ratio of minimum length to the maximum length of the particle. A small AR value indicates the elongated shape of the particle.

FIG. 6c is a graph showing the iPSs′ circularity which is defined as the degree of similarity to a circle (ranging from 0, non-circular, to 1, perfectly circular). The degree of similarity to a circle is calculated using the ImageJ program (see: https://en.wikipedia.org/wiki/ImageJ ) available from the National Institutes of Health and the Laboratory for Optical and Computational Instrumentation, University of Wisconsin. Image J is available as an open-source program. The captured images are converted into 8-bit binary images and calculated and displayed using ImageJ’s “Analyze Particles” function. The data is then exported into Microsoft Excel to generate a scatter plot.

FIG. 6d is a graph showing the iPSs′ diameter in µm. Similar to FIG. 6c above, the iPSs′ diameter is calculated by ImageJ to measure the particles’ Feret’s diameter. This data is then exported into Microsoft Excel to generate a scatter plot.

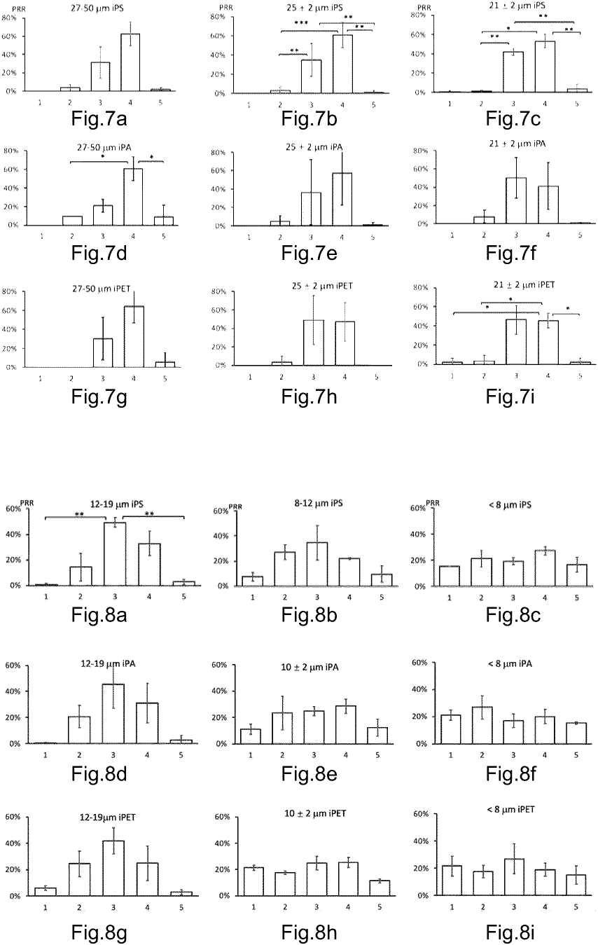

FIGS. 7 shows the PRRs of iPS MPs, irregular polyamide (iPA) MPs, and irregular polyethylene terephthalate (iPET) MPs greater than 19 µm in diameter in a system similar to that of FIGS. 3c and 3e. As with FIGS. 6 above, outlet 1 = outlet 24a, outlet 2 = outlet 24b, outlet 3 = outlet 24c, outlet 4 = outlet 24d, and outlet 5 = outlet 24e in FIG. 3c. FIG. 7a shows the PRR distribution of 27-50 µm iPS MPs, with the highest PRR in outlet 4, and the majority in outlets 3 and 4. FIG. 7b shows the PRR distribution of 25 ± 2 µm iPS MPs, with the highest PRR in outlet 4, and the majority in outlets 3 and 4. FIG. 7c shows the PRR distribution of 21 ± 2 µm of iPS MPs with the highest PRR in outlet 4, and the majority in outlets 3 and 4. FIG. 7d shows the PRR distribution of 27-50 µm iPA MPs, with the highest PRR in outlet 4, and the majority in outlets 3 and 4, although some recovery is seen in outlet 5. FIG. 7e shows the PRR distribution of 25 ± 2 µm iPA MPs, with the highest PRR in outlet 4, and the majority in outlets 3 and 4. FIG. 7f shows the PRR distribution of 21 ± 2 µm of iPA MPs with the highest PRR in outlet 3, and the majority in outlets 3 and 4. FIG. 7g shows the PRR distribution of 27-50 µm iPET MPs, with the highest PRR in outlet 4, and the majority in outlets 3 and 4. FIG. 7h shows the PRR distribution of 25 ± 2 µm iPET MPs, with the highest PRR in equally in outlets 3 and 4, and the majority in outlets 3 and 4. FIG. 7i shows the PRR distribution of 21 ± 2 µm of iPET MPs with the highest PRR in equally in outlets 3 and 4, and the majority in outlets 3 and 4. Data shown is the mean ± SD of three independent experiments where *p < 0.01, **p < 0.001, ***p < 0.0001.

FIGS. 8a-8i show the PRRs for iPS MPs, iPA MPs, and iPET MPs below the estimated threshold (< 19 µm) in a system similar to that of FIGS. 3c and 3e. As with FIGS. 6 above, outlet 1 = outlet 24a, outlet 2 = outlet 24b, outlet 3 = outlet 24c, outlet 4 = outlet 24d, and outlet 5 = outlet 24e in FIG. 3c. FIG. 8a, shows the PRR distribution of iPS MPs 12-19 µm in diameter with the highest PRR in outlet 3 with the majority in outlets 2-4. FIG. 8b shows the PRR distribution of iPS MPs 10 ± 2 µm in diameter, with a bell-shaped curve centered on outlet 3. FIG. 8c shows the PRR distribution of iPS MPs < 8 µm in diameter with a roughly even PRR distribution across outlets 1-5, although outlet 4 is slightly higher than the rest. FIG. 8d shows the PRR distribution of iPA MPs 12-19 µm in diameter, with the highest PRR in outlet 3, and the majority in outlets 2-4. FIG. 8e shows the PRR distribution of iPA MPs 10 ± 2 µm in diameter, with the PRR distribution roughly equal across outlets 2-4, and with some MPs found in outlets 1 and 5. FIG. 8f s shows the PRR distribution of iPA MPs < 8 µm in diameter and a roughly equal PRR distribution across outlets 1-5, although outlet 2 is slightly higher than the rest. FIG. 8g shows the PRR distribution of iPET MPs 12-19 µm in diameter with the highest PRR found in outlet 3, and the majority found in outlets 2-4. FIG. 8h shows the PRR distribution of iPET MPs 10 ± 2 µm in diameter, with a roughly equal PRR distribution across all of outlets 1-5, although the PRR from outlet 5 is slightly lower than the rest. FIG. 8i shows the PRR distribution of iPET MPs < 8 µm diameter, with a roughly equal PRR across outlets 1-4, with outlet 3 being slightly higher, and outlet 5 being slightly lower. Data shown is the mean ± SD of three independent experiments where *p < 0.01, **p < 0.001, ***p < 0.0001.

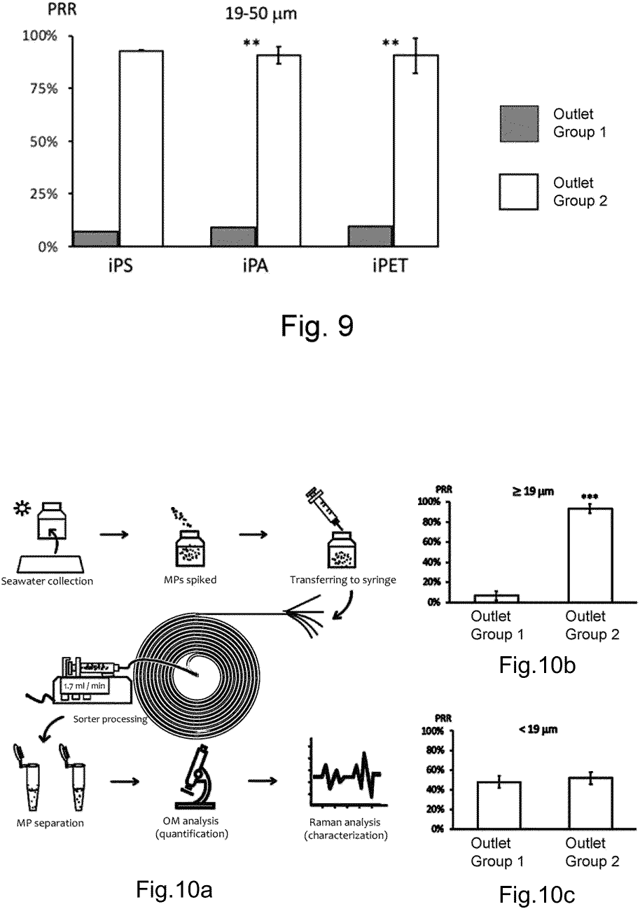

FIG. 9 shows a PRR graph of iPS, iPA and iPET MPs 19-50 µm in diameter according to two groups of outlets in a system similar to that of FIGS. 3c and 3e. As with FIGS. 6 above, outlet 1 = outlet 24a, outlet 2 = outlet 24b, outlet 3 = outlet 24c, outlet 4 = outlet 24d, and outlet 5 = outlet 24e in FIG. 3c. Outlet Group 1 = outlets 1, 2 and 5, while Outlet Group 2 = outlets 3 and 4. Data shown is the mean ± SD of three independent experiments where *p < 0.01, **p < 0.001, ***p < 0.0001.

FIG. 10a shows schematic workflow diagram of an embodiment of a spiked seawater preparation, separation and analysis using a microfluidic chamber. FIG. 10b shows ≥ 19 µm MP PRRs spiked into the seawater of FIG. 10a, when tested by the invention similar to that seen in FIGS. 3c and 3e. As with FIG. 9 above, outlet 1 = outlet 24a, outlet 2 = outlet 24b, outlet 3 = outlet 24c, outlet 4 = outlet 24d, and outlet 5 = outlet 24e in FIG. 3c. Outlet Group 1 = outlets 1, 2 and 5, while Outlet Group 2 = outlets 3 and 4. In FIG. 10b, MPs ≥ 19 µm were spiked into the seawater. A great majority of the MPs were recovered from Group 2. FIG. 10c, shows < 19 µm MP PRRs spiked into the seawater of FIG. 10a, when tested by the invention similar to that seen in FIGS. 3c and 3e. The PRR was essentially equally-divided between the outlets in Group 1 and Group 2. In FIGS. 10b and 10c, data shown is the mean ± SD of three independent experiments where *p < 0.01, **p < 0.001, ***p < 0.0001.

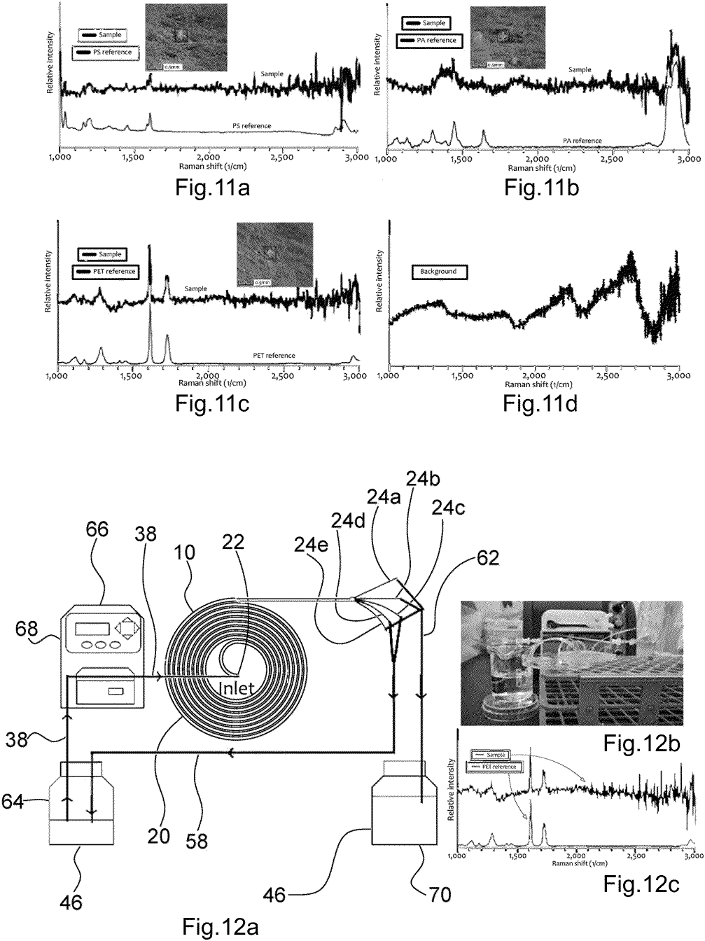

FIG. 11a shows a representative Raman spectra graph and photo of iPS MPs recovered from Outlet Group 2. FIG. 11b shows a representative Raman spectra graph and photo of iPA MPs recovered from Outlet Group 2. FIG. 11c shows a representative Raman spectra graph and photo of iPET MPs recovered from Outlet Group 2. As with FIG. 9 above, outlet 1 = outlet 24a, outlet 2 = outlet 24b, outlet 3 = outlet 24c, outlet 4 = outlet 24d, and outlet 5 = outlet 24e in FIG. 3c. Outlet Group 1 = outlets 1, 2 and 5, while Outlet Group 2 = outlets 3 and 4. FIG. 11a shows representative iPS Raman spectra of MPs recovered from Outlet Group 2. FIG. 11b shows representative iPA Raman spectra of MPs recovered from Outlet Group 2. FIG. 11c shows representative iPET Raman spectra of MPs recovered from Outlet Group 2. All sample (iPS, iPA, and iPET) spectra have already subtracted the control background spectra. FIG. 11d shows a representative background spectrum, which was the result of averaging five spectra taken without MP.

FIG. 12a shows a schematic diagram of an embodiment of the present invention integrating a feedback loop, allowing simultaneous MP sample concentration and water purification. The system, 60, incorporates the sorting system, 32, of FIG. 2, and further includes two collection containers, 46, a feedback loop, 58, and a purified water tube, 62. Specifically, starting with a collection container, 46, which in this case is a concentration container, 64, a tube, 38, leads to a pump, 66, which in this case may be a peristaltic pump, 68, and then through the tube, 38, to the inlet, 22, of the microfluidic chamber, 10. The microfluidic chamber in this case is a large microfluidic chamber, 20, similar to that shown in FIG. 2 and contains five outlets, 24a, 24b, 24c, 24d, 24e. Outlets 1, 2 and 5 are combined into Outlet Group 1 and outlets 3 and 4 are combined into Outlet Group 2. The output from Outlet Group 1 is collected and combined by purified water tube, 62, and deposited into purified water container, 70. Meanwhile the output from Outlet Group 2 is collected in feedback loop, 58, and returned to concentration container, 64, to allow for continuous recycling and sorting. The peristaltic pump, 68, is continuously run at a rate of about 0.32 ml/min.

FIG. 12b shows a photo of the embodiment of FIG. 12a.

FIG. 12c shows a Raman spectrum of isolated MPs (top) and the PET reference spectrum (bottom) showing similar peaks.

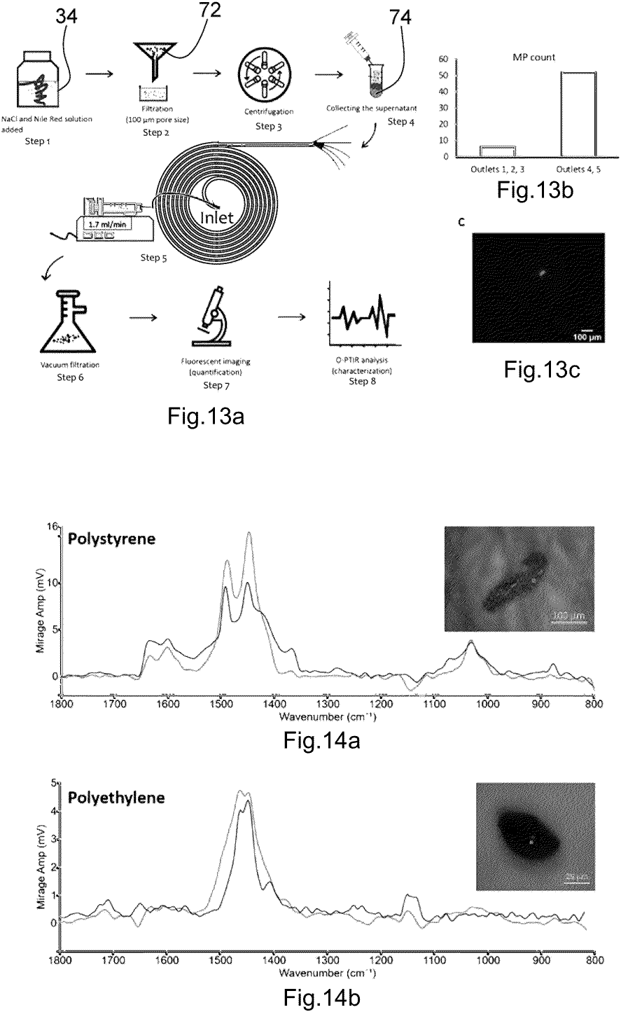

FIG. 13a shows an embodiment of a schematic workflow diagram of a MP sorting protocol analysis from deep-sea sediment using the microfluidic chamber, 10. In Step 1, NaCl and Nile Red stain solution are added to the MP sample, 34, which in this case is deep-sea sediment. In Step 2, the MP sample, 34, is run through a filter, 72, having a 100 µm pore size. In Step 3, the MP sample, 34, is placed into a centrifuge, to remove the high-density sediment, 74, such as clay.

FIG. 13b shows the count of all recovered MPs (15-215 µm) at Outlets 1, 2, 3 and Outlets 4, 5 respectively. FIG. 13c shows the representative fluorescence images of the recovered Nile red-stained MPs.

FIG. 14a shows the representative spectra of a PS MP that recovered from deep-sea sediment. FIG. 14a shows the representative spectra of a polyethylene (PE) MP that recovered from deep-sea sediment. These figures show that the deep-sea sediment contains polystyrene and polyethylene. The dots correspond to the two scanning locations of optical photothermal infrared spectroscopy (O-PTIR) spectra.

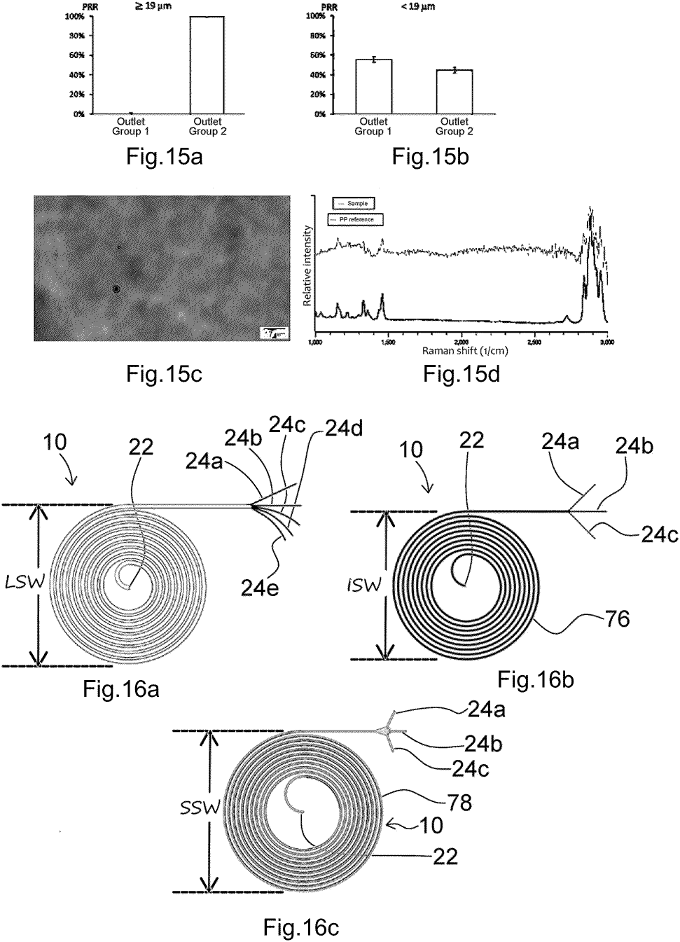

FIGS. 15 shows the detection and characterization of microparticles (MPs) from polypropylene (PP) food containers. FIG. 15a shows the PRR of ≥ 19 µm PP. MPs collected from Outlet Group 1 and Outlet Group 2, and that virtually all of the MPs are recovered from Outlet Group 2. FIG. 15b shows the PRR of < 19 µm PP. MPs collected from Outlet Group 1 and Outlet Group 2, where the MPs are almost equally divided between Outlet Group 1 and Outlet Group 2. FIG. 15c shows a representative optical microscopy image of the particles from a PP container. FIG. 15d shows a representative Raman spectrum of the enriched MPs (pink) and a PP reference spectrum (black). Data are shown as mean ± SD of three independent experiments; *p < 0.01, **p < 0.001, ***p < 0.0001.

FIG. 16a shows a schematic diagram of an embodiment of a large microfluidic chamber. FIG. 16b shows a schematic diagram of an embodiment of an intermediate microfluidic chamber. FIG. 16c shows a schematic diagram of an embodiment of a small microfluidic chamber. In FIGS. 16a-16c, the microfluidic chambers, 10, possess different sizes. A large microfluidic chamber, 32, has a large microfluidic chamber width, LSW, of 2 cm, while an intermediate microfluidic chamber, 76, has an intermediate microfluidic chamber width, ISW, of 1.2 cm, and a small microfluidic chamber, 78, has a small microfluidic chamber width, SSW, of 0.45 cm. Each of the microfluidic chambers, 10, contains an inlet, 22. The large microfluidic chamber, 20, has five outlets, 24a, 24b, 24c, 24d, 24e, as previously-described.

The intermediate microfluidic chamber, 76, has three outlets, 24a, 24b, 24c. The cross-sectional width, w, cross-sectional height, h, sub-channel width, ws, and sub-channel height, hs, of the large microfluidic chamber, 20, are as described with respect to FIG. 1. With respect to the intermediate microfluidic chamber, 76, the cross-sectional width, w, is 125 µm while the cross-sectional height, h, is 100 µm while the outlet 24a and 24b have a sub-channel width, ws, of 50 µm and the outlet 24c has a sub-channel width, ws, of 25 µm. All of the outlets, 24a, 24b, 24c, in the intermediate microfluidic chamber, 76, have a sub-channel height, hs, of 100 µm.

The small microfluidic chamber, 78, has three outlets, 24a, 24b, 24c, similar to the intermediate microfluidic chamber, but they are of different dimensions. Specifically, the cross-sectional width, w, is 50 µm while the cross-sectional height, h, is 50 µm. The outlet 24a and 24b have a sub-channel width, ws, of 20 µm and the outlet 24c has a sub-channel width, ws, of 10 µm. All of the outlets, 24a, 24b, 24c, in the small microfluidic chamber, 76, have a sub-channel height, hs, of 50 µm.

FIG. 17shows a schematic diagram of an embodiment of a sorting system with multiple microfluidic chambers, 10, connected in series. Specifically, a pump, 66, specifically a syringe pump, 36, pushes a MP sample, 34, having various-sized MPs through a tube, 38, operatively-connected to the inlet, 20, of the large microfluidic chamber, 20. The sample, 44, of outlets 24c and 24d (see FIGS. 16) of the large microfluidic chamber, 20, are collected into specimen container, 80a, while the sample, 44, of outlets 24a, 24b and 24e (see FIGS. 16) is combined in tube 38 and fed to the inlet, 22, of intermediate microfluidic chamber, 76. The sample, 44, of outlets 24a and 24c (see FIGS. 16) of the intermediate microfluidic chamber, 76, are collected in specimen container, 80b, while the sample, 44, of outlet 24b (see FIGS. 16) is collected in tube 38, and fed into the inlet, 22, of small microfluidic chamber, 76. The sample, 44, of outlets 24a and 24c (see FIGS. 16) of the small microfluidic chamber, 78, are collected in specimen container, 80c, while the sample, 44, of outlet 24b (see FIGS. 16) is collected in specimen container 80d. Specimen container 80a contains mostly MPs > 19 µm in diameter, specimen container 80b contains mostly MPs from 8-19 µm in diameter, specimen container 80c contains mostly MPs from 3-8 µm in diameter, and specimen container 80d contains mostly MPs < 3 µm in diameter.

### Example 1

### Microfluidic Chamber Fabrication

A spiral-shaped first microfluidic chamber is formed as shown in FIG. 1 with one first chamber inlet and five first chamber outlets. The cross-sectional shape of the first chamber inlet is a rectangle 500 µm in width (w) and 220 µm in height (h) and forms a channel. After ten spiral loops, the channel is evenly divided into five sub-channels, each of which leads to a first chamber outlet. Each of the 5 first chamber outlets is 100 µm w × 220 µm h.

The microfluidic chamber is fabricated using standard soft lithography with polydimethylsiloxane (PDMS) as the construction material. First, polydimethylsiloxane (PDMS) was prepared by silicon elastomer mixed with a curing agent (Dow, Germany) in a 10:1 ratio. Next, the prepared PDMS was poured over an aluminum mold with a designed channel pattern (master). The PDMS was subsequently cured at 70° C. for 2 hours, and the patterned PDMS was slowly taken off from the aluminum mold. The first chamber inlet and the 5 first chamber outlets of 1.5 mm diameter were produced with a biopsy puncher (Integra, USA). The patterned PDMS with first chamber inlet and first chamber outlet holes was then bonded to a slide via oxygen plasma treatment for 5 min and baked in an oven at 70° C. for 30 min to create the microfluidics chamber (see FIG. 3d).

A similarly-shaped second microfluidic chamber with one second chamber inlet and three second chamber outlets is formed in a similar manner, with a second chamber inlet of 125 µm w × 100 µm h. After ten spiral loops, the channel was evenly divided into the three sub-channels, each of which led to a second chamber outlet. The center second chamber outlets is 25 µm w × 100 µm h, while the inner second chamber outlet and outer second chamber outlets are each 20 µm w × 100 µm h. (see FIGS. 16).

A similarly-shaped third microfluidic chamber with one third chamber inlet and five third chamber outlets is formed in a similar manner, with a third chamber inlet of 50 µm w × 22 µm h. After ten spiral loops, the channel was evenly divided into the five sub-channels, each of which is 30 µm w × 22 µm h.

### Example 2

### Preparation of iPS, iPA, and iPETparticles

Polystyrene (PS), polyamide (PA), and polyethylene terephthalate (PET) materials for making irregular polystyrene (iPS), irregular polyamide (iPA), and irregular polyethylene terephthalate (iPET) particles are purchased form a commercial vendor. The plastics are ground by a Retsch CryoMill cryogenic grinder (Haan, Germany) into a mixture of particles with different sizes and shapes (see FIGS. 6). The grinder is set at five shakes per second (precooling stage). After 7 min, the grinding speed is increased to 25 shakes per second (grinding stage) for 1.5 min with liquid nitrogen for constant cooling. Next, the ground MP particles were placed in a commercial teabag (DAISO, Japan) to filter out larger particles (> 50 µm) that may otherwise clog the microfluidic device.

### Preparation of iPS, iPA, and iPETparticle Suspensions

An iPS suspension is prepared by adding 0.01 g of dried iPS particles (grounded PS) to 15 ml distilled water. This is further diluted by transferring 0.5 ml prepared iPS suspension to 19.5 ml distilled water. The final concentration is determined to be 1.67×10⁻⁵ g/ml iPS. Similar iPA and iPET suspensions are prepared to maintain constant final concentrations.

### Processing of the Microfluidic Device

1.5 ml centrifugal tubes are placed on a centrifuge test tube holder. A 10 ml syringe with 2 ml distilled water (water syringe) is inserted into a syringe pump (New Era Pump Systems Inc., USA). Flexible plastic tubing (Tygon, USA) connects a first microfluidic chamber, syringe, and centrifugal tubes, respectively (see FIG. 3e). The distilled water is pumped at 1.7 ml /min for at least 15 seconds to completely fill the channel with distilled water. The water syringe is replaced with the sample syringe containing 1 ml sample and is immediately run at an optimized flow rate (1.7 ml/min) for 30 seconds. Subsequently, the collected sample is transferred to a 24-well plate (SPL Life Science, Korea) for optical microscopic analysis. Each set of samples is repeated three times to obtain the average particle recovery rate (PRR).

### Removal Efficacy of PS Microspheres With Different Sizes

Although the threshold calculated by Equation (5) was around 21 µm, the particle focus may still vary depending on the actual channel parameters (e.g., geometries, aspect ratio). As such, we tested the processing of PS microspheres of different sizes (1-21 µm) with the microfluidic device to evaluate their focusing potential. For 21 µm microbeads, 97 ± 4% were recovered at outlet 4 (see FIG. 5a), while 15 µm PS microbeads were recovered at Outlets 3 and 4 (55 ± 5% and 45 ± 5%, respectively) (see FIG. 5b). These results indicated that the focusing potential of 21 µm microspheres was significantly higher than that of 15 µm microspheres, and the threshold was around 21 µm, which conformed to Equation (5), that is, PS microspheres > 21 µm would be focused at similar efficiency as the 21 µm microspheres. For 10 µm PS microspheres (see FIG. 5c), some microspheres could be concentrated and recovered from outlet 3 (36%), demonstrating the presence of a low focusing potential. For the microspheres that are much smaller than 21 µm (i.e., < 10 µm), the particles were evenly distributed across all Outlets (15%-23% PRRs) (see FIGS. 5d-f).

### Example 3

### Size Threshold Optimization Using iPS, iPA, and iPA Particles

Due to the high heterogeneity in shape and size of MP in environmental samples, we applied the use of irregular polystyrene (iPS), polyamide (iPA), and polyethylene terephthalate (iPET) particles of different sizes (< 50 µm) (see FIGS. 6). The densities of most common polymers range from about 0.9 to about 1.5 g/cm³ [2, 14, 29], which is one of the factors that influence focusing potential. Therefor we categorized their densities into low (0.9-1.1 g/cm³), middle (1.1-1.3 g/cm³), and high (1.3-1.5 g/cm³) respectively. The selection of PS (1.05 g/cm³), PA (1.15 g/cm³), and PET (1.4 g/cm³) was due to their corresponding densities covering the above categories.

To characterize sorting efficiency based on the focusing potential of the microspheres, irregular particles could be classified into six groups according the following Feret’s diameters: < 8 µm, 10 µm, 12-19 µm, 21 µm, 25 µm and 27-50 µm.

Apart from density, the shape of the particle also affects inertial focusing. Using the microfluidic device in FIG. 1, we demonstrated that the PRR of 21 ± 2 µm iPS particles in first chamber outlet 4 was 53 ± 7% (see FIG. 7c), which was significantly lower than that with PS microspheres (see FIG. 5a where PRR = 97% in outlet 4). Also, 35 ± 14% of 10 µm iPS particles could still be focused and retrieved from first chamber outlet 3 (see FIG. 8b), while < 8 µm iPS particles were completely unfocused and resulted in uniform distribution across all first chamber outlets (see FIG. 8c). Since increasing the size of iPS particles above 21 µm did not significantly enhance the focusing effect (see FIGS. 7a-b), it was confirmed that the size threshold for iPS particles remained around 21 ± 2 µm (or 19 µm more precisely), similar to that of PS microspheres.

We obtained similar results with iPA and iPET particles. Specifically, more than 90% of the larger iPA and iPET particles (i.e., 19-50 µm) were focused and retrieved from first chamber outlet 3 and first chamber outlet 4 (see FIGS. 7d-i), and the focusing potential for particles < 19 µm was reduced (see FIGS. 8d-i). Overall, the results suggested that the size threshold of iPS, iPA, and iPET particles were around 19 µm.

### Example 4

### Identification of Target Outlets for Maximum Particle Recovery Rate (PRR)

Two groups of MP were screened, namely those < 19 (m (< threshold value) and 19 -50 (m (≥ threshold value) using a microfluidic device containing a single first microfluidic chamber as shown in FIG. 1. Since iPS, iPA, and iPET particles larger than 19 µm were mainly concentrated in first chamber outlet 3 and first chamber outlet 4, we defined Outlet group 1 as those obtained from first chamber outlet 1, first chamber outlet 2, and first chamber outlet 5 and Outlet group 2 as those obtained from first chamber outlet 3 and first chamber outlet 4. We hypothesized that the collection of Outlet group 2 would maximize the MP removal efficiency, as we demonstrated that the PRR of 19 - 50 µm iPS, iPA, and iPET particles exceeded 90 % with Outlet group 2 (see FIG. 9).

### Example 5

### First Microfluidic Chamber Efficacy Using Seawater Sample Spiked With MP

### Preparation of Seawater Spiked With MP

Seawater sampled from Starfish Way, Hong Kong is transferred to the laboratory. Tests of the collected seawater confirm that it does not contain a significant amount of MPs. 0.01 g of dried iPS, iPA, and iPET particles are spiked into the 100 ml seawater to mimic contaminated seawater samples. The final MP concentration of the spiked seawater is 3×10⁻⁵ g/ml.

Using the optimized procedure described above in EXAMPLE 4 and in (see FIGS. 10), we evaluated the separation efficiency of the microfluidic device to remove MPs from seawater. Before device processing, the seawater was spiked with iPS, iPA, and iPET particles, respectively (see FIG. 10a). We demonstrated that 93% of particles ≥ 19 µm could be efficiently collected within outlets 3 and 4 (Outlet group 2) (see FIG. 10b). For particles < 19 µm, the PRRs of Outlet group 1 and Outlet group 2 were 48% and 52%, respectively (FIG. 10c). The recovered iPS, iPA, and iPET were characterized using Raman spectrometry, including method blanks (see FIGS. 11).

The microfluidic device effectively removes 19-50 µm MP particles (> 90% PRR) from spiked seawater samples.

### Example 6

### Water Purification Via Microfluidic Device

In an example of the water purification system herein, designed system concentrates all particles > 19 µm (20.4-43.3 µm) into a small volume by a factor of 100x (from 50 ml to 0.5 ml via outlets 3 and 4), and the concentrated particles were characterized by Raman spectra (see FIGS. 11). Since MPs could be highly concentrated to a very small volume, water purification was achieved through outlets 1, 2, and 5 (Outlet group 1). Therefore, the system could concentrate MPs from a large volume of samples, simultaneously allowing the purification of contaminated water.

### Example 7

### Demonstration of the Microfluidic Chamber With Deep-sea Sediment

### Sediment Collection

Dear sea sediment from the Great Australian Bight is provided by CSIRO Hobart extracted by a polycarbonate sediment core remotely-operated from a survey vessel. The collected samples are immediately wrapped in aluminum foil are frozen.

During sampling, all personnel wear cotton fiber overalls to minimize sampling contamination via airborne plastic fibers from clothing. During sampling onboard, cotton over suits are worn by all personnel involved, and the mini-core sampling tubes and wrapping foil are pre-rinsed with DI water. During laboratory analysis all equipment is pre-rinsed with DI water before use. Whenever possible, glass equipment is used, and all procedures are carried out within a fume cabinet or biological safety cabinet to avoid airborne contamination.

### Sediment Pre-Treatment, Processing, and Analysis

A 6 g sediment sample is dissolved in water in a 1:2 ratio. NaCl and Nile Red dye solutions are added to the sediment suspension to give a final concentration of 0.30 g/ml and 10 µg/ml, respectively (see FIG. 14a). NaCl is applied to separate MP from higher-density materials, and Nile Red dye is used for MP staining. The mixture is processed by a vortex mixer and subject to MP staining for 10 min. The mixture is then filtered through a nylon net (100 µm pore size) to isolate all undissolved sediment and Nile Red crystals. The filtered solution was centrifuged at 2000 rpm for 5 min to isolate organic impurities that were also positive for Nile red.

The supernatant is collected and processed using the first microfluidic chamber at 1.7 ml/min. The sample collected from Outlets was vacuum filtered together onto a cellulose ester membrane filter paper (0.45 µm pore size). The filter paper is imaged using a fluorescent microscope (green filter) for MP counting (see FIGS. 13b-c). A vertical line marked the top of the filter paper and the positions of MPs to the left of the fragment. The marked filter paper is then characterized using the O-PTIR for MP characterization. SpectraBase is used to compare the collected spectra to characterize the identity of the MP (see FIGS. 14).

Blank NaCl solutions containing 20 µm green PS beads, 5 µm red PS beads, and 1 µm green PS beads are used to test separation and evaluate if the microfluidic device or syringe employed shed any plastic MPs. Only the PS beads are recovered, and no irregular shaped MPs, like those observed from the sediment, are detected. In addition to the blanks focused on the microfluidic device, two types of full separation process blanks are employed: 1) green 20 µm PS beads and Nile Red dye in NaCl solution; 2) Nile Red dye in NaCl solution. These solutions followed all steps of the MP isolation process outlined in FIGS. 13, including the initial filtration and centrifugation steps. Only PS beads were recovered for blank type 1, and no irregular-shaped MPs were detected for either type of blank.

The separation efficiency of the first microfluidic chamber to remove MP from deep-sea sediments collected at two locations (B and E) from the Great Australian Bight is described. These samples are challenging to analyze since a very low concentration of MPs is present in a complex matrix, including organic debris and sand which can affect particle distribution and sorting efficiency. Hence, they cannot be directly injected into the microfluidic device.

Instead, samples were treated with Nile red dye, filtered, and centrifuged before processing with the microfluidic device following previously reported procedures (see FIG. 13a). The Nile red dye was added to stain MP present in the sediment and to aid optical microscope identification of the particles in the MPC. The stain combined with centrifugation also allows discrimination between sediment-based MP and non-MP impurities.

The microfluidic device concentrates the MP sample into a small volume rather than isolating it in a distributed fashion on filter paper. Using a single microfluidic chamber, approximately 90% of the MPs present in the sample after organic debris and sand removal could be recovered in first chamber outlet 4 and first chamber outlet 5 (see FIG. 13b), reflecting a shift of particle focal positions with deep-sea sediment as compared to control samples.

This can be explained by changes in fluidic density caused by pre-treatment solutions such as Nile red dyes and NaCl solutions. In short, it is believed that a higher fluidic density will cause the particles to focus closer to the inner channel. The MP counts (per gram wet sediment) obtained for each location were within the range previously obtained via filtration (Table 2). However, the concentration of the MP sample into a small volume greatly assisted the subsequent transfer of the MP onto a well-defined region of the paper support used for O-PTIR analysis. The procedure increases confidence that all isolated MP were spectroscopically characterized.

TABLE 2

Summary of characterized plastic types for fragments and the microplastic counts for each location. Sample locations in the Great Australian Bight were fully described in ‘Microplastic Pollution in Deep-Sea Sediments From the Great Australian Bight, Frontiers in Marine Science 7 (2020) 808’

| | | |
|---|---|---|
| Sampling location | Microplastic counts (per gram wet sediment) | Type of characterized plastic |
| E3 | 2.3 | Polyurethane Cis-polyisoprene Polystyrene Polyethylene Nylon |
| B6 | 1.2 | Polyester Ammonium polyacrylate Alkyd resin Melamine-formaldehyde resin |
| | | Anionic polymer (Hydraid 771) |
| | | Adhesive (Tuff-Bond®) |

For deep-sea sediment samples, the (single) first microfluidic chamber achieved about 90% of MP separation (15-215 µm) at first chamber outlet 4 and first chamber outlet 5. A portion of the recovered MPs are within the range < 50 µm, which in most filtration techniques do not well detect. By concentrating the MP sample into a small volume before transfer to paper support for imaging, the (single) first microfluidic chamber enables detection of a more comprehensive MP size range in sediment samples. O-PTIR identified 11 plastic types; with three of them being the most prevalent plastics used worldwide (i.e., polystyrene, polyethylene, and polyester), even though a smaller amount of sediment was used than in previous studies which only identified 8 different plastic types. Thus, it is believed that the present system provides improved efficiency and sensitivity vs. previous systems.

### Example 8

### Demonstration of the Microfluidic Device With Plastic Containers

### Preprocessing of Food Container Derived Samples

Polypropylene (PP) food containers are processed to extract MPs to simulate the ingestion of MPs via the use of take-out containers. First, the PP container with DI water is heated by microwave for 3 minutes (to model hot soup in the container). The hot water is contained within the container for at least 30 minutes. The inner surface of the container is then scraped with a spoon to simulate usage. Due to a low amount of MPs present, staining and pre-filtration are not required before processing the sample with the microfluidic device.

With the continuing pandemic of COVID-19, the high demand for take-out services has led to a significant increase in the use of plastic food containers. Polypropylene (PP) food storage containers are widely used in the food industry due to their better heat resistance and suitability for microwave heating. In a (single) first microfluidic chamber test, all particles with a diameter larger than the optimized threshold (≥ 19 µm) were well focused within the first chamber outlets in Outlet group 2, corresponding to a PRR of 100% (see FIG. 15a). For particles below the threshold (< 19 µm), they were evenly distributed across all first chamber outlets (see FIG. 15b). Therefore, the microfluidic chamber is validated for the efficient enrichment and removal of ≥ 19 µm MPs from various samples.

### Example 9

### Demonstration of High Throughput Process

Verification of a microfluidic chamber modified to enable high throughput. Recently, media attention focused on MPs detected in PET bottled mineral water. Given that the amount of small MPs (> 20 µm) in bottled mineral water is very low (18 ± 13 particles/liter), a modification of the microfluidic device with a feedback loop verifies the simultaneous concentration and removal of MPs from PET bottled water (see FIGS. 12). The modified setup could concentrate all particles > 19 µm (20.4-43.3 µm) into a small volume; i.e., a 100x fold concentrate from 50 ml to 0.5 ml via Outlet group 2. In other words, water purification (or MP removal) could be achieved by collecting the sample via Outlet group 1. Hence, the system could be simultaneously utilized to concentrate MPs and purify water (by removing MPs).

### Example 10

### Feedback Loop System for Water Purification

A feedback loop for water purification is creates as follows: 50 ml of bottled mineral water is introduced into a microfluidic device containing a (single) first microfluidic chamber through a peristaltic pump (BT101S, Lead Fluid Technology Co., Ltd, China) at about 1.7 ml/min to validate the incorporation of the feedback loop system. The sample collected from Outlet group 2 (i.e., first chamber outlet 3 and first chamber outlet 4) is routed back into the sample reservoir and the inlet of the fist microfluidic chamber, forming a feedback loop system (FIG. 12a). Samples are continuously processed until the final volume is concentrated by about 100 fold.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

All references specifically cited herein are hereby incorporated by reference in their entireties. However, the citation or incorporation of such a reference is not necessarily an admission as to its appropriateness, citability, and/or availability as prior art to/against the present invention.

### REFERENCES

C. Arthur, J.E. Baker, H.A. Bamford, Proceedings of the International Research Workshop on the Occurrence, Effects, and Fate of Microplastic Marine Debris, September 9-11, 2008, University of Washington Tacoma, Tacoma, WA, USA, (2009).

N.P. Ivleva, A.C. Wiesheu, R. Niessner, Microplastic in Aquatic Ecosystems, Angew Chem Int Ed Engl 56(7) (2017) 1720-1739. https://doi.org/10.1002/anie.201606957.

M. Cole, P. Lindeque, C. Halsband, T.S. Galloway, Microplastics as contaminants in the marine environment: a review, Mar Pollut Bull 62(12) (2011) 2588-97. https://doi.org/10.1016/j.marpolbul.2011.09.025.

E. Hermsen, S.M. Mintenig, E. Besseling, A.A. Koelmans, Quality Criteria for the Analysis of Microplastic in Biota Samples: A Critical Review, Environ Sci Technol 52(18) (2018) 10230-10240. https://doi.org/10.1021/acs.est.8b01611.

F. Welle, R. Franz, Microplastic in bottled natural mineral water - literature review and considerations on exposure and risk assessment, Food Addit Contam Part A Chem Anal Control Expo Risk Assess 35(12) (2018) 2482-2492. https://doi.org/10.1080/19440049.2018.1543957.

F. Du, H. Cai, Q. Zhang, Q. Chen, H. Shi, Microplastics in take-out food containers, J Hazard Mater 399 (2020) 122969. https://doi.org/10.1016/j.jhazmat.2020.122969.

N. Parashar, S. Hait, Plastics in the time of COVID-19 pandemic: Protector or polluter?, Science of The Total Environment (2020) 144274.

D. Li, Y. Shi, L. Yang, L. Xiao, D.K. Kehoe, YK. Gun’ko, J.J. Boland, J.J. Wang, Microplastic release from the degradation of polypropylene feeding bottles during infant formula preparation, Nature Food 1(11) (2020) 746-754.

K. Mattsson, E.V. Johnson, A. Malmendal, S. Linse, L.-A. Hansson, T. Cedervall, Brain damage and behavioural disorders in fish induced by plastic nanoparticles delivered through the food chain, Scientific reports 7(1) (2017) 1-7.

R.C. Hale, Analytical challenges associated with the determination of microplastics in the environment, Analytical Methods 9(9) (2017) 1326-1327. https://doi.org/10.1039/c7ay90015e.

A.K. Kniggendorf, C. Wetzel, B. Roth, Microplastics Detection in Streaming Tap Water with Raman Spectroscopy, Sensors (Basel) 19(8) (2019). https://doi.org/10.3390/s19081839.

F. Galgani, G. Hanke, S. Werner, L. Oosterbaan, P. Nilsson, D. Fleet, S. Kinsey, R.C. Thompson, J. Van Franeker, T. Vlachogianni, Guidance on monitoring of marine litter in European Seas, Publications Office of the European Union 2013.

B. Nguyen, D. Claveau-Mallet, L.M. Hernandez, E.G. Xu, J.M. Farner, N. Tufenkji, Separation and Analysis of Microplastics and Nanoplastics in Complex Environmental Samples, Acc Chem Res 52(4) (2019) 858-866. https://doi.org/10.1021/acs.accounts.8b00602.

J.S. Hanvey, P.J. Lewis, J.L. Lavers, N.D. Crosbie, K. Pozo, B.O. Clarke, A review of analytical techniques for quantifying microplastics in sediments, Analytical Methods 9(9) (2017) 1369-1383.

V. Hidalgo-Ruz, L. Gutow, R.C. Thompson, M. Thiel, Microplastics in the marine environment: a review of the methods used for identification and quantification, Environ Sci Technol 46(6) (2012) 3060-75. https://doi.org/10.1021/es2031505.

A.A. Bhagat, S.S. Kuntaegowdanahalli, I. Papautsky, Continuous particle separation in spiral microchannels using Dean flows and differential migration, Lab Chip 8(11) (2008) 1906-14. https://doi.org/10.1039/b807107a.

H.K. Imhof, J. Schmid, R. Niessner, N.P. Ivleva, C. Laforsch, A novel, highly efficient method for the separation and quantification of plastic particles in sediments of aquatic environments, Limnology and Oceanography: Methods 10(7) (2012) 524-537. https://doi.org/10.4319/lom.2012.10.524.

Y. Akiyama, T. Egawa, K. Koyano, H. Moriwaki, Acoustic focusing of microplastics in microchannels: A promising continuous collection approach, Sensors and Actuators B: Chemical 304 (2020). https://doi.org/10.1016/j.snb.2019.127328.

J. Grbic, B. Nguyen, E. Guo, J.B. You, D. Sinton, C.M. Rochman, Magnetic extraction of microplastics from environmental samples, Environmental Science & Technology Letters 6(2) (2019) 68-72.

S. Felsing, C. Kochleus, S. Buchinger, N. Brennholt, F. Stock, G. Reifferscheid, Anew approach in separating microplastics from environmental samples based on their electrostatic behavior, Environmental Pollution 234 (2018) 20-28.

Y. Gou, Y. Jia, P. Wang, C. Sun, Progress of Inertial Microfluidics in Principle and Application, Sensors (Basel) 18(6) (2018). https://doi.org/10.3390/s18061762.

J. Zhang, S. Yan, D. Yuan, G. Alici, N.-T. Nguyen, M.E. Warkiani, W. Li, Fundamentals and applications of inertial microfluidics: a review, Lab on a Chip 16(1) (2016) 10-34.

J.M. Martel, M. Toner, Inertial focusing in microfluidics, Annu Rev Biomed Eng 16 (2014) 371-96. https://doi.org/10.1146/annurev-bioeng-121813-120704.

A.A. Bhagat, S.S. Kuntaegowdanahalli, N. Kaval, C.J. Seliskar, I. Papautsky, Inertial microfluidics for sheath-less high-throughput flow cytometry, Biomed Microdevices 12(2) (2010) 187-95. https://doi.org/10.1007/s10544-009-9374-9.

J. Barrett, Z. Chase, J. Zhang, M.M.B. Holl, K. Willis, A. Williams, B.D. Hardesty, C. Wilcox, Microplastic Pollution in Deep-Sea Sediments From the Great Australian Bight, Frontiers in Marine Science 7 (2020) 808.

D. Di Carlo, D. Irimia, R.G. Tompkins, M. Toner, Continuous inertial focusing, ordering, and separation of particles in microchannels, Proc Natl Acad Sci U S A 104(48) (2007) 18892-7. https://doi.org/10.1073/pnas.0704958104.

B.L. Khoo, C. Bouquerel, P. Durai, S. Anil, B. Goh, B. Wu, L. Raman, R. Mahendran, T. Thamboo, E. Chiong, C.T. Lim, Detection of Clinical Mesenchymal Cancer Cells from Bladder Wash Urine for Real-Time Detection and Prognosis, Cancers (Basel) 11(9) (2019). https://doi.org/10.3390/cancers11091274.

C.K. Chen, B.L. Khoo, A density-based threshold model for evaluating the separation of particles in heterogeneous mixtures with curvilinear microfluidic channels, Scientific reports 10(1) (2020) 1-12.

D. Van Krevelen, K. Te Nijenhuis, Mechanical properties of solid polymers, Properties of polymers (2009) 383-503.

S.C. Hur, S.-E. Choi, S. Kwon, D.D. Carlo, Inertial focusing of non-spherical microparticles, Applied Physics Letters 99(4) (2011) 044101.

D. Schymanski, C. Goldbeck, H.U. Humpf, P. Furst, Analysis of microplastics in water by micro-Raman spectroscopy: Release of plastic particles from different packaging into mineral water, Water Res 129 (2018) 154-162. https://doi.org/10.1016/j.watres.2017.11.011.

A.L. Lusher, K. Munno, L. Hermabessiere, S. Carr, Isolation and Extraction of Microplastics from Environmental Samples: An Evaluation of Practical Approaches and Recommendations for Further Harmonization, Appl Spectrosc 74(9) (2020) 1049-1065. https://doi.org/10.1177/0003702820938993.

M. Wagner, C. Scherer, D. Alvarez-Muñoz, N. Brennholt, X. Bourrain, S. Buchinger, E. Fries, C. Grosbois, J. Klasmeier, T. Marti, S. Rodriguez-Mozaz, R. Urbatzka, A.D. Vethaak, M. Winther-Nielsen, G. Reifferscheid, Microplastics in freshwater ecosystems: what we know and what we need to know, Environmental Sciences Europe 26(1) (2014) 12. https://doi.org/10.1186/s12302-014-0012-7.

J.R. Jambeck, R. Geyer, C. Wilcox, T.R. Siegler, M. Perryman, A. Andrady, R. Narayan, K.L. Law, Plastic waste inputs from land into the ocean, Science 347(6223) (2015) 768-771.

D. Qin, Y. Xia, G.M. Whitesides, Soft lithography for micro-and nanoscale patterning, Nature protocols 5(3) (2010) 491.

Y.K. Song, S.H. Hong, M. Jang, G.M. Han, M. Rani, J. Lee, W.J. Shim, A comparison of microscopic and spectroscopic identification methods for analysis of microplastics in environmental samples, Mar Pollut Bull 93(1-2) (2015) 202-9. https://doi.org/10.1016/j.marpolbul.2015.01.015.

What is claimed is:

1) A microfluidic device for isolating a microparticle from a heterogeneous sample comprising:
A) a first microfluidic chamber comprising:
i) a first chamber inlet; and
ii) a plurality of first chamber outlets in fluid connection with the first chamber inlet,
wherein the first microfluidic chamber comprises a loop; or from about 1 loop to about 50 loops; or from about 2 loops to about 25 loops; or from about 5 loops to about 15 loops;
B) a second microfluidic chamber comprising:
i) a second chamber inlet; and
ii) a plurality of second chamber outlets in fluid connection with the second chamber inlet, and
wherein the second microfluidic chamber comprises a loop; or from about 1 loop to about 50 loops; or from about 2 loops to about 25 loops; or from about 5 loops to about 15 loops,
wherein a first chamber outlet; or a plurality of first chamber outlets, is in fluid connection
with the second chamber inlet.

2) The microfluidic device according to claim 1, wherein the first microfluidic chamber is larger; or at least 50% larger; or from about 50% to about 1000% larger; or from about 100% to about 500% larger than the second microfluidic chamber in at least one dimension, and wherein at least one of the plurality of first chamber outlets is in fluid connection with the second chamber inlet.

3) The microfluidic device according to claim a, further comprising:
C) a third microfluidic chamber comprising:
i) a third chamber inlet; and
ii) a plurality of third chamber outlets in fluid connection with the third chamber inlet,
wherein the third microfluidic chamber comprises a loop; or from about 1 loop to about 50 loops; or from about 2 loops to about 25 loops; or from about 5 loops to about 15 loops,
wherein the second microfluidic chamber is larger; or at least 50% larger; or from about 50% to about 1000% larger; or from about 100% to about 500% larger than the third microfluidic chamber in at least one dimension, and wherein at least one of the plurality of second chamber outlets is in fluid connection with the third chamber inlet.

4) The microfluidic device according to claim 1, wherein the microparticle is from about 5 mm to about 0.1 µm; or from about 1 mm to about 0.5 µm; or from about 500 µm to about 1 µm, as measured across the predetermined-sized particle’s largest Feret’s Diameter.

5) The microfluidic device according to claim 1, wherein at least a portion of the microfluidic device produced by a method comprising lithography, 3D printing, and a combination thereof.

6) A method for removing microparticle from a heterogeneous sample comprising the steps of:
A) injecting the heterogeneous sample into a first chamber inlet of the microfluidic device according to any one of the previous claims ; and
B) collecting microparticle from the first chamber outlet.

7) The method according to claim 6, wherein the heterogeneous sample comprises water; or water selected from the group consisting of lake water, river water, seawater and a combination thereof; or seawater.

8) The method according to claim 5, further comprising the step of filtering the heterogeneous sample prior to injecting the heterogeneous sample to the first chamber inlet.

9) A water purification system comprising the microfluidic device according to claim 1.

10) A method for purifying water comprising the method according to claim 6.
